(19) United States
(12) Patent Application Publication
(10) Pub. No.: US 2025/0067848 A1
(43) Pub. Date: Feb. 27, 2025

(54) SEMICONDUCTOR DEVICE

(71) Applicant: CANON KABUSHIKI KAISHA, Tokyo (JP)

(72) Inventors: YU MAEHASHI, Hokkaido (JP); NORIYUKI SHIKINA, Tokyo (JP)

(21) Appl. No.: 18/801,972

(22) Filed: Aug. 13, 2024

(30) Foreign Application Priority Data
Aug. 25, 2023 (JP) 2023-137310

(51) Int. Cl. G01S 7/481; G01S 17/931

(52) U.S. Cl. CPC G01S 7/4816; G01S 17/931

(57) ABSTRACT

A semiconductor device includes: a signal generation unit configured to generate a first signal; a synchronization unit configured to synchronize the first signal with any one of a second signal and a third signal that are input from an outside and are synchronized with each other; and a control unit configured to control at least one of the second signal and the third signal based on the first signal after synchronization is performed by the synchronization unit. The synchronization unit performs the synchronization by matching a timing at which a potential of the first signal changes to a later one of a timing at which a potential of the second signal changes and a timing at which a potential of the third signal changes.

### BACKGROUND

### Technical Field

The present invention relates to a semiconductor device.

### Description of the Related Art

Japanese Patent Application Laid-Open No. 2005-167920 discloses a synchronization circuit that synchronizes a plurality of signals that are asynchronous with each other and outputs the synchronized signals to other circuits.

In a semiconductor device having a function of synchronizing a signal input from the outside with a signal generated in the inside, more suitable synchronization and control of the signals may be required.

An object of the present invention is to provide a semiconductor device capable of suitably synchronizing and controlling signals.

### SUMMARY

According to a disclosure of the present specification, there is provided a semiconductor device including: a signal generation unit configured to generate a first signal; a synchronization unit configured to synchronize the first signal with any one of a second signal and a third signal that are input from an outside and are synchronized with each other; and a control unit configured to control at least one of the second signal and the third signal based on the first signal after synchronization is performed by the synchronization unit. The synchronization unit performs the synchronization by matching a timing at which a potential of the first signal changes to a later one of a timing at which a potential of the second signal changes and a timing at which a potential of the third signal changes.

Further features of the present invention will become apparent from the following description of exemplary embodiments with reference to the attached drawings.

### BRIEF DESCRIPTION OF THE DRAWINGS

FIG. 1 is a block diagram illustrating a configuration example of a photoelectric conversion device according to a first embodiment.

FIG. 2 is a block diagram illustrating a configuration example of a pixel according to the first embodiment.

FIG. 3 is a timing chart illustrating an operation of the pixel according to the first embodiment.

FIG. 4 is a block diagram illustrating a configuration example of a vertical scanning circuit according to the first embodiment.

FIG. 5 is a timing chart illustrating an operation of the vertical scanning circuit according to the first embodiment.

FIG. 6 is a block diagram illustrating a configuration example of a vertical scanning circuit according to a second embodiment.

FIG. 7 is a block diagram illustrating a configuration example of a pixel according to the second embodiment.

FIG. 8 is a timing chart illustrating an operation of the vertical scanning circuit according to the second embodiment.

FIG. 9 is a block diagram illustrating a configuration example of a vertical scanning circuit according to a third embodiment.

FIG. 10 is a timing chart illustrating an operation of the vertical scanning circuit according to the third embodiment.

FIG. 11 is a block diagram of a photodetection system according to a fourth embodiment.

FIG. 12 is a block diagram of a photodetection system according to a fifth embodiment.

FIG. 13 is a schematic diagram of an endoscopic surgery system according to a sixth embodiment.

FIG. 14 is a schematic diagram of a photodetection system according to a seventh embodiment.

FIGS. 15A, 15B, and 15C are schematic diagrams of a movable body according to the seventh embodiment.

FIG. 16 is a flowchart illustrating an operation of the photodetection system according to the seventh embodiment.

FIGS. 17A and 17B are diagrams illustrating specific examples of an electronic device according to an eighth embodiment.

### DESCRIPTION OF THE EMBODIMENTS

Hereinafter, embodiments of the present invention will be described with reference to the drawings. The same or corresponding elements are denoted by the same reference numerals throughout the several drawings, and the description thereof may be omitted or simplified.

### First Embodiment

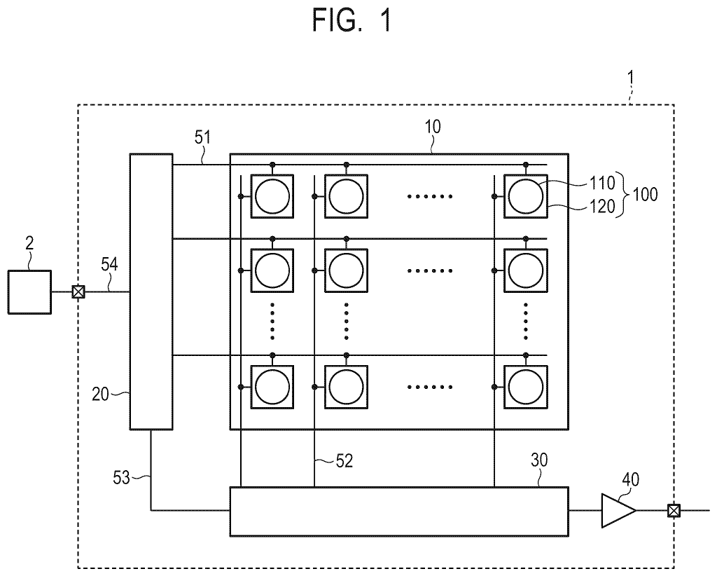

FIG. 1 is a block diagram of a photoelectric conversion device 1 according to the present embodiment. The photoelectric conversion device 1 may be, for example, a solid-state imaging device, a focus detection device, a ranging device, or the like.

Time-of-Flight (ToF) is one of ranging methods in a ranging device. ToF is a method of measuring a distance from a ranging device to an object based on a time from when light is emitted from a light source to when reflected light from the object is received by a pixel of the ranging device.

Further, as one type of ToF, there is a time gate type ToF. In the time gate type ToF, the ranging device can selectively detect reflected light from an object at a distance corresponding to a photon detection period by detecting a photon incident within the photon detection period. Here, the photon detection period is determined by a control signal (gate pulse) indicating a gate window. By obtaining the distance corresponding to the photon detection period in which the reflected light is detected, the distance information to the object can be obtained. In the following description, it is assumed that the photoelectric conversion device 1 of the present embodiment is a ranging device that performs ranging using the time gate type ToF.

Since the control signal indicating the gate window needs to be synchronized with the light emission of the light source, the control signal may be input from the outside of the chip constituting the photoelectric conversion device 1. On the other hand, a control signal used for signal readout in the photoelectric conversion device 1 may be generated in the photoelectric conversion device 1. In general, since a control signal generated inside the photoelectric conversion device 1 and a control signal input from the outside of the photoelectric conversion device 1 are asynchronous, it is necessary to synchronize these control signals in the photoelectric conversion device 1. In some cases, control for enabling or disabling a control signal input from the outside of the photoelectric conversion device 1 is performed using a control signal generated inside the photoelectric conversion device 1. The photoelectric conversion device 1 of the present embodiment includes a semiconductor device such as a synchronization circuit that synchronizes a plurality of asynchronous control signals as described above.

Note that, in this specification, “synchronization” includes not only a state in which a plurality of timings indicated by a plurality of signals are controlled so as to be simultaneous, but also a state in which the timings are controlled so as to have a predetermined time difference. In addition, “asynchronous” means a state in which these controls are not performed and a plurality of timings indicated by a plurality of signals are independently determined. The timing is, for example, the time of the rising edge or the falling edge of the signal. For example, when a plurality of signals are controlled so that the time difference of the edge time becomes a predetermined value (including zero), the plurality of signals are synchronized. In addition, an operation of adjusting one or more timings of the plurality of signals so that the plurality of timings indicated by the plurality of signals become the same or a predetermined time difference may be referred to as “synchronize”.

The photoelectric conversion device 1 includes a pixel array 10, a vertical scanning circuit 20, a digital front-end circuit (hereinafter referred to as DFE) 30, an output circuit 40, output lines 52, control signal line groups 51, a control signal line group 53, and a control signal line group 54. The pixel array 10 includes a plurality of pixels 100 arranged to form a plurality of rows and a plurality of columns. Each of the plurality of pixels 100 includes a photoelectric conversion unit 110 including an avalanche photodiode (hereinafter, referred to as APD), and a pixel signal processing unit 120. The photoelectric conversion unit 110 converts incident light into an electrical signal. The pixels 100 in each column are connected to the output line 52 arranged for each column and extending in the column direction. The pixel signal processing unit 120 outputs the converted electrical signal to the DFE 53 via the output line 52 of the corresponding column. The row direction refers to the left and right directions in FIG. 1, and the column direction refers to the up and down directions in FIG. 1. Each of the control signal line group 51, the control signal line group 53, and the control signal line group 54 includes a plurality of control signal lines.

The vertical scanning circuit 20 receives a control signal that is input from an external device 2 arranged outside the semiconductor chip constituting the photoelectric conversion device 1 via the control signal line group 54 and a control signal that is input from the DFE 30 via the control signal line group 53. Based on these control signals, the vertical scanning circuit 20 supplies control signals to each of the plurality of pixels 100 via a control signal line group 51 arranged for each row and extending in the row direction. A logic circuit such as a shift register or an address decoder may be used as the vertical scanning circuit 20.

The external device 2 is, for example, a control device for a ranging device that supplies control signals to a light source and the photoelectric conversion device 1. The control signal output from the external device 2 to the vertical scanning circuit 20 is input to the vertical scanning circuit 20 at a timing synchronized with light emission timing of the light source for ranging arranged outside the photoelectric conversion device 1. This control signal is supplied to the pixels 100 after predetermined control is performed in the vertical scanning circuit 20, and is used to control the photon detection period in the pixels 100. Accordingly, the photoelectric conversion device 1 can selectively detect a photon incident on the photoelectric conversion device 1 at a time delayed by a predetermined time from the light emission timing of the light source, and can acquire, for example, an image of an object at a specific distance. Further, by repeating the measurement while changing the photon detection period, that is, the distance at which the measurement is performed, the photoelectric conversion device 1 can obtain the distance information of the object.

A signal input from each of the plurality of pixels 100 to the DFE 30 is processed in the DFE 30. The DFE 30 outputs the processed signal to a storage device or a signal processing device outside the photoelectric conversion device 1 via the output circuit 40.

The pixels 100 may be arranged one-dimensionally. In addition, the pixel signal processing unit 120 may not necessarily be provided for each the pixels 100. For example, one pixel signal processing unit 120 may be shared by a plurality of pixels 100. In this case, the pixel signal processing unit 120 provides a signal processing function to the plurality of pixels 100 by sequentially processing the signals output from the plurality of photoelectric conversion units 110.

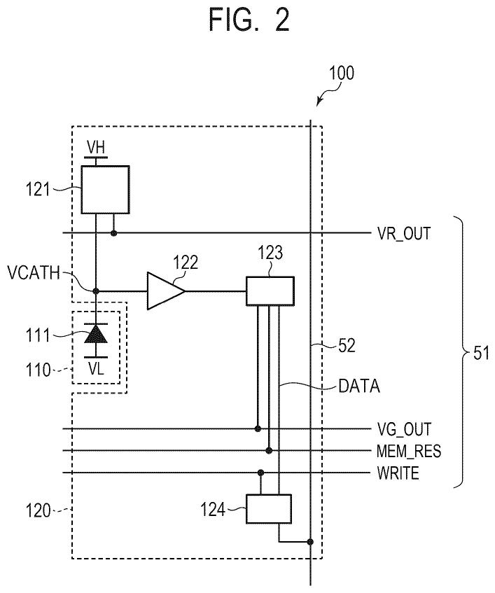

FIG. 2 is a schematic block diagram illustrating a configuration example of one pixel of the photoelectric conversion unit 110 and the pixel signal processing unit 120 according to the present embodiment. In FIG. 2, control signal lines constituting the control signal line group 51 between the vertical scanning circuit 20 and the pixel signal processing unit 120 in FIG. 1 are individually illustrated.

The photoelectric conversion unit 110 includes an APD 111. The pixel signal processing unit 120 includes a recharge circuit 121, a waveform shaping unit 122, a storage unit 123, and a selection circuit 124. The recharge circuit 121 is, for example, a MOS transistor, and has a first terminal, a second terminal, and a control terminal. The pixel signal processing unit 120 may include the recharge circuit 121 and at least one of the waveform shaping unit 122, the storage unit 123, and the selection circuit 124.

The APD 111 generates a charge according to incident light by photoelectric conversion. The potential VL is supplied to an anode of the APD 111. A cathode of the APD 111 is connected to the first terminal of the recharge circuit 121 and an input terminal of the waveform shaping unit 122. A potential of the connection node between the cathode of the APD 111, the first terminal of the recharge circuit 121, and the waveform shaping unit 122 is VCATH. The second terminal of the recharge circuit 121 is supplied with a potential VH higher than a potential VL supplied to the anode of the APD 111. Thus, the anode and the cathode of the APD 111 are supplied with a reverse bias voltage that causes the APD 111 to perform an avalanche multiplication operation. In the APD 111 to which the reverse bias voltage is supplied, when a charge is generated by incident light, the charge causes avalanche multiplication, and an avalanche current is generated.

Operation modes when the reverse bias voltage is supplied to the APD 111 includes a Geiger mode and a linear mode. In the Geiger mode, the APD 111 operates at a state in which a potential difference between the anode and the cathode is larger than the breakdown voltage. In the linear mode, the APD 111 operates at a state in which the potential difference between the anode and the cathode is close to or lower than the breakdown voltage. The APD 111 may operate in the linear mode or may operate in the Geiger mode.

The APD operated in the Geiger mode is referred to as a single photon avalanche diode (SPAD). In this case, for example, the potential VL is −30 V and the potential VH is 1 V.

The recharge circuit 121 has a function of converting a change in the avalanche current generated in the APD 111 into a voltage signal. The recharge circuit 121 is controlled by a control signal VR_OUT that is input to a control terminal via one control signal line of the control signal line group 51. The recharge circuit 121 can switch between a state in which a quenching operation is performed and a state in which a recharge operation is performed in accordance with the control signal VR_OUT. In the quenching operation, the recharge circuit 121 functions as a load circuit (quenching circuit) at the time of signal multiplication by avalanche multiplication, and suppresses the voltage supplied to the APD 111 to suppress avalanche multiplication. The recharge operation is an initialization operation of supplying the potential VH to the cathode of the APD 111 to initialize the cathode potential, thereby returning to a state in which avalanche multiplication is possible again.

The waveform shaping unit 122 shapes the potential change of the cathode of the APD 111 obtained at the time of photon detection and outputs a pulse signal. As the waveform shaping unit 122, for example, an inverter circuit or a monostable circuit using an inverter circuit is used.

The storage unit 123 stores the presence or absence of a pulse signal input from the waveform shaping unit 122 within a predetermined period. The storage unit 123 may be configured to store only a signal indicating whether or not a pulse signal is input, or may be configured to include a counter that counts and stores the number of pulse signals. The storage unit 123 is controlled by control signals VG_OUT and MEM_RES input to control terminals via two control signal lines of the control signal line group 51. In response to the control signal VG_OUT, the storage unit 123 can switch between an input reception state in which an input of the pulse signal can be received and a holding state in which information of the pulse signal being input is held. That is, the control signal VG_OUT indicates the timing of holding a signal in the storage unit 123. The storage unit 123 can initialize a stored value in accordance with the control signal MEM_RES. That is, the control signal MEM_RES indicates timing for initializing a signal based on incident light to the APD 111.

The selection circuit 124 is controlled by a control signal WRITE input to a control terminal via one control signal line of the control signal line group 51. The selection circuit 124 outputs the signal held in the storage unit 123 to the output line 52 in response to the control signal WRITE. That is, the control signal WRITE indicates the timing of signal output from the pixel 100. The selection circuit 124 includes, for example, a buffer circuit for outputting a signal.

In the example of FIG. 2, the selection circuit 124 controls the signal output from the storage unit 123 to the output line 52, but the method of controlling the signal output to the output line 52 is not limited thereto. For example, a switch such as a transistor may be arranged at a node between the recharge circuit 121 and the APD 111 or between the photoelectric conversion unit 110 and the pixel signal processing unit 120, and the signal output to the output line 52 may be controlled by switching between electrical connection and non-connection. Alternatively, the signal output to the output line 52 may be controlled by changing the value of the potential VH or VL supplied to the photoelectric conversion unit 110 using a switch such as a transistor.

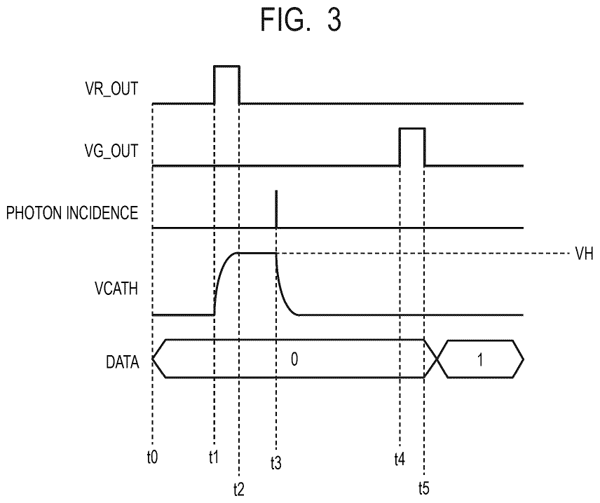

FIG. 3 is a timing chart illustrating an operation of the pixel 100 according to the present embodiment. FIG. 3 illustrates the control signals VR_OUT and VG_OUT, the cathode potential VCATH of the APD 111, and an output signal DATA of the storage unit 123. The “photon incidence” in FIG. 3 indicates the incidence timing of a photon on the APD 111. The recharge circuit 121 performs a quenching operation when the control signal VR_OUT is at the low level, and performs a recharge operation when the control signal VR_OUT is at the high level. The storage unit 123 is in the holding state when the control signal VG_OUT is at the low level, and is in the input reception state when the control signal VG_OUT is at the high level.

It is assumed that avalanche multiplication occurs in the APD 111 due to incident light at a time before time to. Thus, at the time to, the potential VCATH is lower than the potential VH. At the time to, the control signals VR_OUT and VG_OUT are at the low level, and the value of the output signal DATA is “0”.

At time t1, the control signal VR_OUT transitions from the low level to the high level. As a result, the state of the recharge circuit 121 is switched to a state in which the recharge operation is performed. As a result, the potential VCATH is recharged to the potential VH.

At time t2, the control signal VR_OUT transitions from the high level to the low level. As a result, the state of the recharge circuit 121 is switched to a state in which the quenching operation is performed.

When a photon enters the APD 111 at time t3, a reverse current due to avalanche multiplication flows through the APD 111. At this time, since the recharge circuit 121 is in the state in which the quenching operation is performed, the potential VCATH falls. After that, when the potential drop amount further increases and the reverse bias voltage applied to the APD 111 decreases, the avalanche multiplication in the APD 111 stops, and the dropping of the potential VCATH stops at a certain constant value. When the potential VCATH transitions across the threshold value of the waveform shaping unit 122, the potential change is shaped by the waveform shaping unit 122. The shaped signal is input to the storage unit 123.

At time t4, the control signal VG_OUT transitions from the low level to the high level. As a result, the state of the storage unit 123 is switched to the input reception state. At this time, since the input signal to the storage unit 123 is at the low level due to the photon incident at the time t3, the storage unit 123 receives the signal at the low level indicating the photon detection.

At time t5, the control signal VG_OUT transitions from the high level to the low level. As a result, the state of the storage unit 123 is switched to the holding state. At this time, the output signal DATA of the storage unit 123 is updated, and the value of the output signal DATA transitions from “0” to “1”. A period from the time t2 when the control signal VR_OUT becomes the low level to the time t5 when the control signal VG_OUT becomes the low level is the photon detection period in the APD 111. That is, the photon detection period in the APD 111 is controlled by the timings of the falling edges of the pulses of the control signals VR_OUT and VG_OUT.

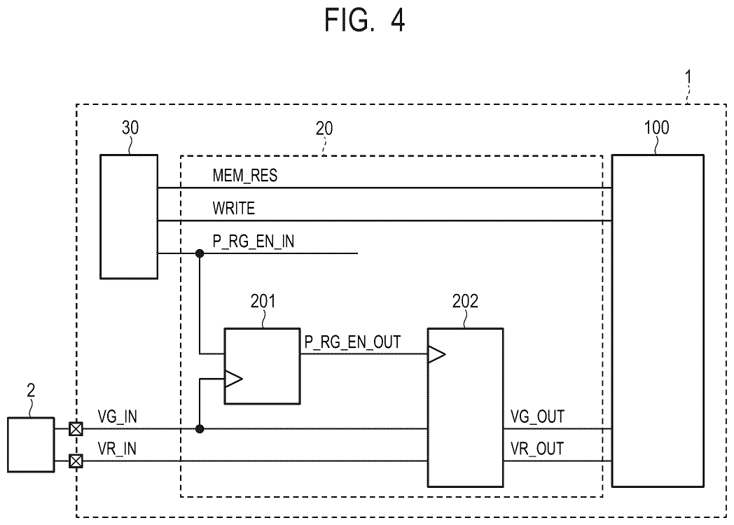

Next, a method of generating the control signals VR_OUT, VG_OUT, MEM_RES, and WRITE that are input to the pixel 100 will be described. FIG. 4 is a block diagram illustrating a configuration example of the vertical scanning circuit 20 according to the present embodiment. FIG. 4 illustrates the configuration of the vertical scanning circuit 20 and the connection relationship among the vertical scanning circuit 20, the DFE 30, the pixel 100, and the external device 2 in more detail. The vertical scanning circuit 20 includes a synchronizer 201 (synchronization unit) and a control circuit 202 (control unit). The vertical scanning circuit 20 is a semiconductor device that synchronizes input control signals.

As described above, the external device 2 is arranged outside the semiconductor chip constituting the photoelectric conversion device 1. The external device 2 outputs a control signal VG_IN (third signal) and a control signal VR_IN (second signal) to the vertical scanning circuit 20 via the control signal line group 54. The DFE 30 may be arranged in a semiconductor chip constituting the photoelectric conversion device 1. The DFE 30 (signal generation unit) outputs the control signal MEM_RES (sixth signal), the control signal WRITE (fifth signal), and a control signal P_RG_EN_IN (first signal) to the vertical scanning circuit 20 via the control signal line group 53. The control signals VG_IN and VR_IN are synchronized with each other. The control signals MEM_RES, WRITE, and P_RG_EN_IN are also synchronized with each other. Each of the control signals VG_IN and VR_IN and each of the control signals MEM_RES, WRITE, and P_RG_EN_IN are asynchronous with each other.

The control signal P_RG_EN_IN is input to an input terminal of the synchronizer 201. The control signal VG_IN is input to a control terminal of the synchronizer 201. The synchronizer 201 outputs the control signal P_RG_EN_IN as a control signal P_RG_EN_OUT to a control terminal of the control circuit 202 in synchronization with the falling edge of the control signal VG_IN. By this operation, the control signal P_RG_EN_OUT is synchronized with the control signals VG_IN and VR_IN. The synchronizer 201 may include a flip-flop circuit. By holding the control signal P_RG_EN_IN at the timing of the falling edge of the control signal VG_IN, the flip-flop circuit can realize the above-described signal synchronization processing. Alternatively, the synchronizer 201 may include a circuit in which two or more flip-flop circuits are connected in series to prevent propagation of metastable.

The control signals VG_IN and VR_IN are input to input terminals of the control circuit 202. The control circuit 202 controls whether or not to output the control signals VG_IN and VR_IN as the control signals VG_OUT and VR_OUT to the pixel 100 based on the signal level of the control signal P_RG_EN_OUT. That is, the control signal P_RG_EN_OUT is a signal for switching between enabling and disabling of the external outputs of the control signals VG_OUT and VR_OUT from the vertical scanning circuit 20. The control circuit 202 may include a selector or the like to perform the switching processing.

The vertical scanning circuit 20 outputs the input control signals MEM_RES and WRITE to the pixels 100 as it is. As described above, the control signals MEM_RES, WRITE, and P_RG_EN_IN generated inside the photoelectric conversion device 1 and the control signals VG_IN and VR_IN that is input from the outside of the photoelectric conversion device 1 are input to the vertical scanning circuit 20. The vertical scanning circuit 20 outputs the control signals MEM_RES, WRITE, VG_OUT, and VR_OUT to the pixels 100 based on these control signals.

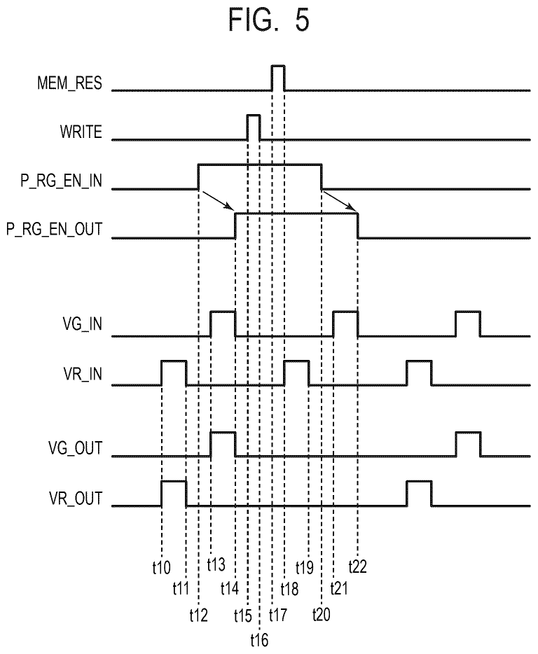

FIG. 5 is a timing chart illustrating an operation of the vertical scanning circuit 20 according to the present embodiment. FIG. 5 illustrates control signals MEM_RES, WRITE, P_RG_EN_IN, P_RG_EN_OUT, VG_IN, VR_IN, VG_OUT, and VR_OUT. Note that the control circuit 202 enables the outputs of the control signals VG_OUT and VR_OUT when P_RG_EN_OUT is at the low level, and the control circuit 202 disables the outputs of the control signals VG_OUT and VR_OUT when P_RG_EN_OUT is at the high level. In addition, the storage unit 123 initializes a stored value at a timing when the control signal MEM_RES becomes the high level. In addition, the selection circuit 124 outputs the signal held in the storage unit 123 to the output line 52 at a timing when the control signal WRITE becomes the high level.

At time t10, the control signal VR_IN becomes the high level. At the time t10, the control signal P_RG_EN_OUT is at the low level, and the output of the control signal VR_OUT in the control circuit 202 is enabled. Therefore, at the time t10, the control signal VR_OUT is also at the high level.

At time t11, the control signal VR_IN becomes the low level. As a result, the control signal VR_OUT also becomes the low level. The operation from the time t10 to the time t11 corresponds to the operation from the time t1 to the time t2 in FIG. 3. That is, when the control signal VR_OUT becomes the high level from the time t10 to the time t11, the pixel 100 performs the recharge operation.

At time t12, the control signal P_RG_EN_IN becomes the high level. Since the control signal VG_IN is maintained at the low level at the time t12, the level of the output signal of the synchronizer 201 does not change at this time. Therefore, at the time t12, the control signal P_RG_EN_OUT remains at the low level.

At time t13, the control signal VG_IN becomes the high level. At the time t13, the control signal P_RG_EN_OUT is at the low level, and the output of the control signal VG_OUT in the control circuit 202 is enabled. Therefore, at the time t13, the control signal VR_OUT also becomes the high level.

At time t14, the control signal VG_IN becomes the low level. As a result, the control signal VG_OUT also becomes the low level. The operation from the time t13 to the time t14 corresponds to the operation from the time t4 to the time t5 in FIG. 3. That is, when the control signal VG_OUT becomes the high level from the time t13 to the time t14, the operation of receiving the signal based on the detection of the photon is performed in the pixel 100, and the value in the storage unit 123 is updated. A period from the time t11 to the time t14 is the photon detection period.

At the time t14, the synchronizer 201 outputs the control signal P_RG_EN_IN as the control signal P_RG_EN_OUT to the control terminal of the control circuit 202 in synchronization with the falling edge of the control signal VG_IN. Accordingly, the control signal P_RG_EN_OUT becomes the high level, and the outputs of the control signals VG_OUT and VR_OUT are disabled.

In this way, the synchronizer 201 synchronizes the control signal P_RG_EN_IN so as to match the falling edge of the signal whose potential changes at the latest time among the control signals VG_IN and VR_IN. Thus, the rising timing of the control signal P_RG_EN_OUT can be set so as not to overlap the photon detection period.

In a period from time t15 to time t16, the control signal WRITE becomes the high level. Accordingly, the selection circuit 124 outputs the signal held in the storage unit 123 to the output line 52.

In a period from time t17 to time t18, the control signal MEM_RES becomes the high level. As a result, the storage unit 123 initializes the stored value.

At the time t18, the control signal VR_IN becomes the high level. At the time t18, the control signal P_RG_EN_OUT is at the high level, and the output of the control signal VR_OUT in the control circuit 202 is disabled. Therefore, at the time t18, the control signal VR_OUT remains at the low level.

At time t19, the control signal VR_IN becomes the low level. Also at this time, the control signal VR_OUT remains at the low level and does not change. As described above, since the control signal VR_OUT is maintained at the low level during the period from the time t18 to the time t19, the recharge operation is not performed in the pixel 100.

At time t20, the control signal P_RG_EN_IN becomes the low level. Since the control signal VG_IN is maintained at the low level at the time t20, the level of the output signal of the synchronizer 201 does not change at this time. Therefore, at the time t20, the control signal P_RG_EN_OUT remains at the high level.

At time t21, the control signal VG_IN becomes the high level. At the time t21, the control signal P_RG_EN_OUT is at the high level, and the output of the control signal VG_OUT in the control circuit 202 is disabled. Therefore, at the time t21, the control signal VG_OUT remains at the low level.

At time t22, the control signal VG_IN becomes the low level. Also at this time, the control signal VR_OUT remains at the low level and does not change. As described above, since the control signal VG_OUT is maintained at the low level during the period from the time t21 to the time t22, the operation of receiving the signal based on the detection of the photon is not performed in the pixel 100.

At the time t22, the synchronizer 201 outputs the control signal P_RG_EN_IN as the control signal P_RG_EN_OUT to the control terminal of the control circuit 202 in synchronization with the falling edge of the control signal VG_IN. Accordingly, the control signal P_RG_EN_OUT becomes the low level, and the outputs of the control signals VG_OUT and VR_OUT are enabled. Since the operation in a period after the time t22 is the same as that described above, the description thereof will be omitted.

As described above, in the period from the time t14 to the time t22 when the control signal P_RG_EN_OUT is at the high level, the exposure control processing related to the detection of the photon and the holding of the value is disabled in the pixel 100. By performing the readout control processing related to the output of the signal from the pixel 100 and the initialization of the storage unit 123 within this period, it is possible to perform the operation so that the processing of both of them do not interfere with each other.

In the present embodiment, the synchronizer 201 synchronizes a signal generated inside the photoelectric conversion device 1 with a signal input from the outside of the photoelectric conversion device 1. Then, the control circuit 202 controls a signal that is input from the outside of the photoelectric conversion device 1 by the synchronized signal. Thus, a signal in the control circuit 202 can be preferably controlled. Therefore, according to the present embodiment, a semiconductor device capable of suitably performing synchronization and control of signals is provided. In addition, by using the signal generated in this manner for the control of the pixel 100, the photoelectric conversion device 1 capable of suitably performing the control even when the signal input from the outside and the signal generated inside are asynchronous with each other is provided. Further, by applying the photoelectric conversion device 1 to generation of control signals for exposure and readout in the time gate type ToF, a ranging device capable of performing suitable ranging is provided.

Although the control circuit 202 of the present embodiment performs control to switch between enabling and disabling of both outputs of the control signals VG_OUT and VR_OUT based on the synchronized control signal P_RG_EN_OUT, the control performed by the control circuit 202 is not limited to this example. For example, the control circuit 202 may control any one of the control signals VG_OUT and VR_OUT. Further, for example, the control circuit 202 may perform, to at least one of the control signals VG_OUT and VR_OUT, control other than enabling and disabling of the output based on the synchronized control signal P_RG_EN_OUT.

### Second Embodiment

In the present embodiment, a modified example of the configurations of the pixel 100 and the vertical scanning circuit 20 of the first embodiment will be described. In the present embodiment, description of elements common to those of the first embodiment may be omitted or simplified.

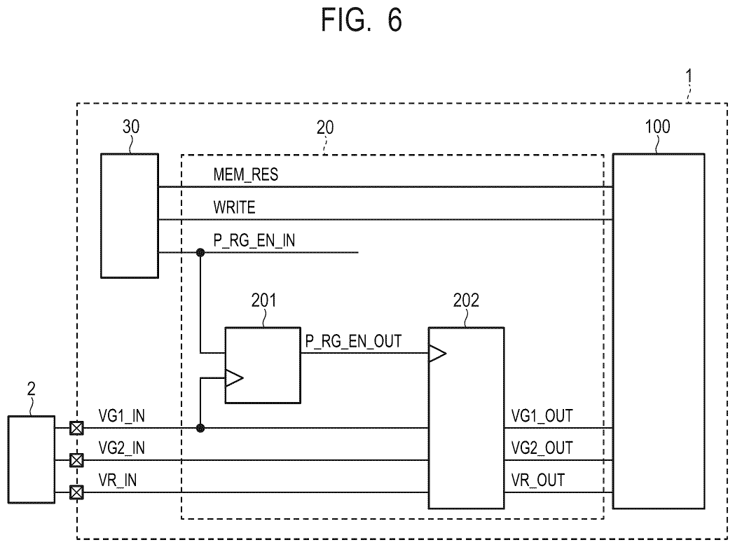

FIG. 6 is a block diagram illustrating a configuration example of the vertical scanning circuit 20 according to the present embodiment. FIG. 6 is different from FIG. 4 in that two control signals VG1_IN (third signal) and VG2_IN (fourth signal) are input to the vertical scanning circuit 20 instead of the control signal VG_IN. The external device 2 outputs the control signals VG1_IN, VG2_IN, and VR_IN to the vertical scanning circuit 20 via the control signal line group 54. The control signals VG1_IN, VG2_IN, and VR_IN are synchronized with each other. Each of the control signals VG1_IN, VG2_IN, and VR_IN and each of the control signals MEM_RES, WRITE, and P_RG_EN_IN are asynchronous with each other.

The control signal VG1_IN is input to the control terminal of the synchronizer 201. The synchronizer 201 outputs the control signal P_RG_EN_IN as the control signal P_RG_EN_OUT to the control terminal of the control circuit 202 in synchronization with the falling edge of the control signal VG1_IN.

The control signals VG1_IN, VG2_IN, and VR_IN are input to input terminals of the control circuit 202. The control circuit 202 controls whether or not to output the control signals VG1_IN, VG2_IN, and VR_IN as control signals VG1_OUT, VG2_OUT, and VR_OUT to the pixel 100 based on the signal level of the control signal P_RG_EN_OUT. That is, the control signal P_RG_EN_OUT is a signal for switching between enabling and disabling of external outputs of the control signals VG1_OUT, VG2_OUT, and VR_OUT from the vertical scanning circuit 20.

The control signals MEM_RES, WRITE, and P_RG_EN_IN generated inside the photoelectric conversion device 1 and the control signals VG1_IN, VG2_IN, and VR_IN input from the outside of the photoelectric conversion device 1 are input to the vertical scanning circuit 20. The vertical scanning circuit 20 outputs the control signals MEM_RES, WRITE, VG1_OUT, VG2_OUT, and VR_OUT to the pixels 100 based on these control signals.

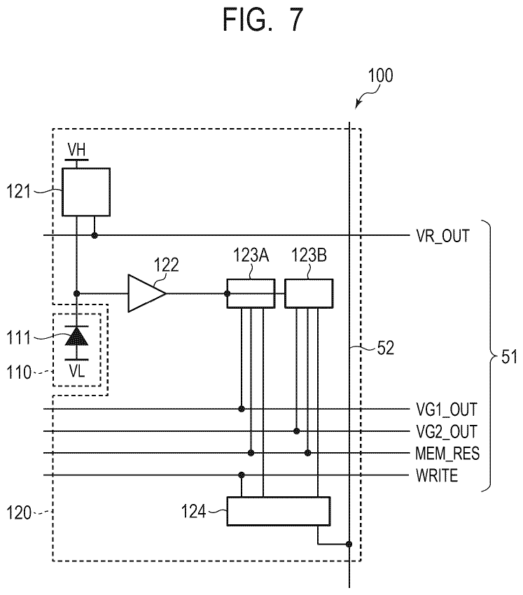

FIG. 7 is a block diagram illustrating a configuration example of the pixel 100 according to the present embodiment. FIG. 7 is different from FIG. 2 in that two storage units 123A and 123B are provided instead of the storage unit 123. The pulse signal output from the waveform shaping unit 122 is input to each of the storage units 123A and 123B. The storage unit 123A is controlled by the control signals VG1_OUT and MEM_RES input to control terminals via two control signal lines of the control signal line group 51. The storage unit 123B is controlled by the control signals VG2_OUT and MEM_RES input to control terminals via two control signal lines of the control signal line group 51. The storage units 123A and 123B can be switched between an input reception state in which input of a pulse signal can be received and a holding state in which information of an input pulse signal is held in accordance with the control signals VG1_OUT and VG2_OUT, respectively. That is, the control signal VG1_OUT indicates the timing of holding a signal in the storage unit 123A, and the control signal VG2_OUT indicates the timing of holding a signal in the storage unit 123B.

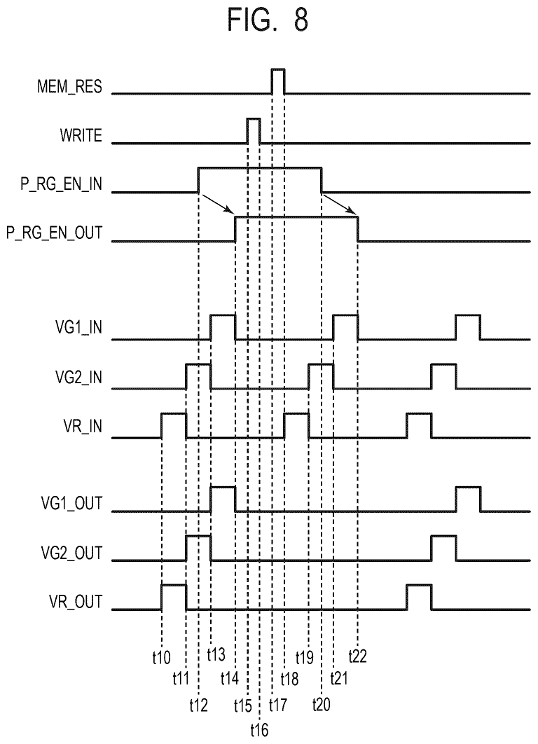

FIG. 8 is a timing chart illustrating an operation of the pixel 100 according to the present embodiment. In FIG. 8, the first difference from FIG. 5 is that the control signal VG2_IN becomes the high level in the period from the time t11 to the time t13, and the control signal VG1_IN becomes the high level in the period from the time t13 to the time t14. In these periods, the control signal P_RG_EN_OUT is at the low level. Therefore, the control signal VG2_OUT becomes the high level in the period from the time t11 to the time t13, and the control signal VG1_OUT becomes the high level in the period from the time t11 to the time t14. In this configuration, the synchronizer 201 outputs the control signal P_RG_EN_IN as the control signal P_RG_EN_OUT to the control terminal of the control circuit 202 in synchronization with the falling edge of the control signal VG1_IN at the time t14. That is, the synchronizer 201 synchronizes the control signal P_RG_EN_IN so as to match the falling edge of the signal whose potential changes at the latest time among the control signals VG1_IN, VG2_IN, and VR_IN.

In FIG. 8, the second difference from FIG. 5 is that the control signal VG2_IN becomes the high level in the period from the time t19 to the time t21, and the control signal VG1_IN becomes the high level in the period from the time t21 to the time t22. In these periods, the control signal P_RG_EN_OUT is at the high level. Therefore, in the period from the time t19 to the time t22, the control signals VG1_OUT and VG2_OUT are maintained at the low level.

The period from the time t11 to the time t14 is a first photon detection period by the storage unit 123A. The period from the time t11 to the time t13 is a second photon detection period by the storage unit 123B. As described above, in the present embodiment, the two storage units 123A and 123B can detect a photon in different photon detection periods and store signals.

In the present embodiment, a semiconductor device, a photoelectric conversion device 1, and a ranging device that can obtain the same effects as those of the first embodiment are provided. In addition, in the present embodiment, the pixel 100 can detect a photon in a plurality of photon detection periods different from each other. This configuration is suitable for, for example, measurement of a temporal change in the light emission amount of an object.

In the present embodiment, the number of storage units in one pixel and the number of types of photon detection periods are both two, but are not limited thereto. That is, the number of storage units in one pixel and the number of types of photon detection periods may be three or more. Although FIG. 8 illustrates an example in which a part of the first photon detection period and a part of the second photon detection period overlap with each other, these periods may not overlap with each other.

### Third Embodiment

In the present embodiment, a modified example of the configurations of the pixel 100 and the vertical scanning circuit 20 of the second embodiment will be described. In the present embodiment, description of elements common to the first or second embodiment may be omitted or simplified.

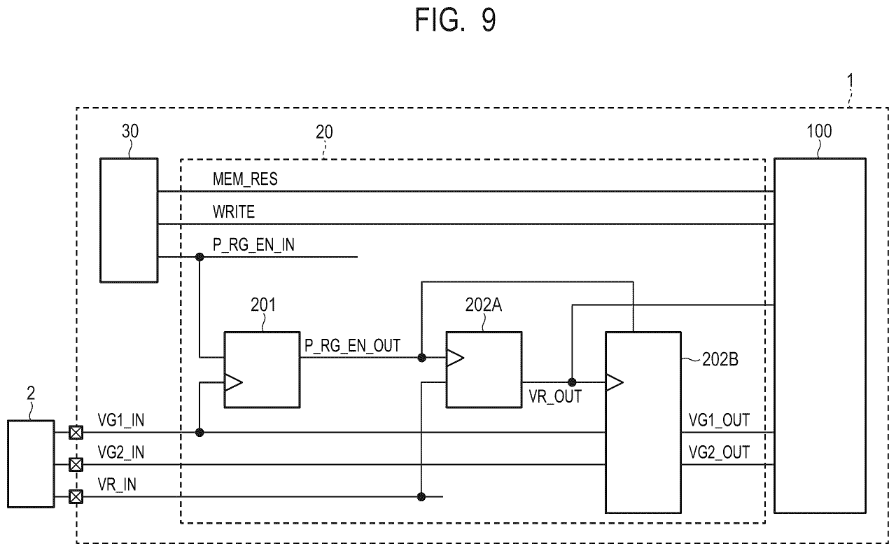

FIG. 9 is a block diagram illustrating a configuration example of the vertical scanning circuit 20 according to the present embodiment. FIG. 9 is different from FIG. 6 in that the control circuit 202 of the vertical scanning circuit 20 is changed to a control unit including two control circuits 202A and 202B. The control signal P_RG_EN_OUT output from the synchronizer 201 is input to a control terminal of the control circuit 202A. The control signal VR_IN is input to an input terminal of the control circuit 202A. The control circuit 202A controls whether or not to output the control signal VR_IN as the control signal VR_OUT based on the signal level of the control signal P_RG_EN_OUT. That is, the control signal P_RG_EN_OUT is a signal for switching between enabling and disabling of the output of the control signal VR_OUT.

The control signal VR_OUT output from the control circuit 202A is input to a first control terminal of the control circuit 202B. The control signal VR_OUT is also output to the pixel 100. The control signal P_RG_EN_OUT output from the synchronizer 201 is also input to a second control terminal of the control circuit 202B. The control signals VG1_IN and VG2_IN are input to input terminals of the control circuit 202B. The control circuit 202B controls whether or not to output the control signals VG1_IN and VG2_IN as the control signals VG1_OUT and VG2_OUT to the pixels 100 based on the signal levels of the control signals P_RG_EN_OUT and VR_OUT. That is, each of the control signals P_RG_EN_OUT and VR_OUT is a signal for switching between enabling and disabling of the external outputs of the control signals VG1_OUT and VG2_OUT from the vertical scanning circuit 20.

In this way, the vertical scanning circuit 20 outputs the control signals MEM_RES, WRITE, VG1_OUT, VG2_OUT, and VR_OUT to the pixels 100. The circuit configuration of the pixel 100 is the same as that in FIG. 7.

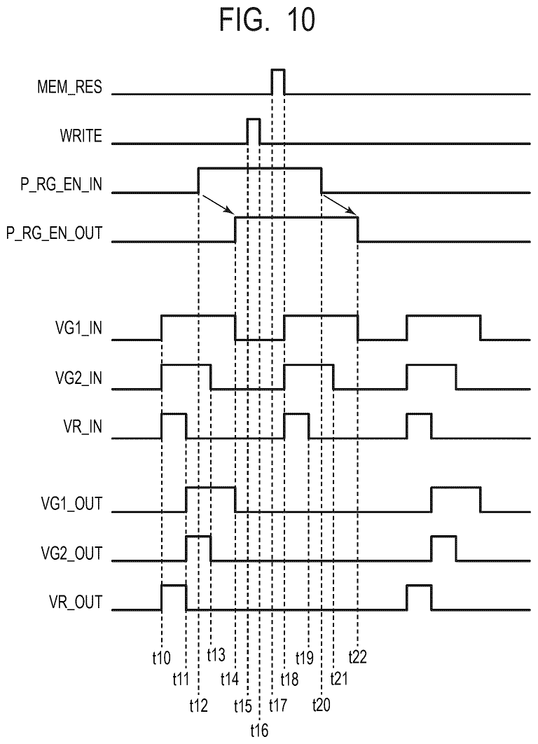

FIG. 10 is a timing chart illustrating an operation of the pixel 100 according to the present embodiment. In FIG. 10, the first difference from FIG. 8 is that the control signal VG2_IN becomes the high level in the period from the time t10 to the time t13, and the control signal VG1_IN becomes the high level in the period from the time t10 to the time t14. That is, a part of the period in which the control signals VG1_IN and VG2_IN are at the high level overlaps with the period in which the control signal VR_IN is at the high level. The control circuit 202B performs control to output the control signals VG1_IN and VG2_IN as the control signals VG1_OUT and VG2_OUT to the pixels 100 from the time t11 when the control signal VR_OUT changes from the high level to the low level. In other words, the control circuit 202B performs control so as not to output the control signals VG1_IN and VG2_IN to the pixels 100 as the control signals VG1_OUT and VG2_OUT in a period in which the control signal VR_OUT is at the high level, for disabling the control signals VG1_OUT and VG2_OUT. Further, the synchronizer 201 synchronizes the control signal P_RG_EN_IN so as to match the falling edge of the signal whose potential falls at the latest time among the control signals VG1_IN, VG2_IN, and VR_IN.

In FIG. 10, the second difference from FIG. 8 is that the control signal VG2_IN becomes the high level in the period from the time t18 to the time t21, and the control signal VG1_IN becomes the high level in the period from the time t18 to the time t22. In these periods, the control signal P_RG_EN_OUT is at the high level. Therefore, in the period from the time t18 to the time t22, the control signals VG1_OUT and VG2_OUT are maintained at the low level.

In the present embodiment, a semiconductor device, a photoelectric conversion device 1, and a ranging device that can obtain the same effects as those of the first and second embodiments are provided. In addition, in the present embodiment, the control signal VR_OUT based on the control signal VR_IN, which is one of the control signals VG1_IN, VG2_IN, and VR_IN synchronized with each other, is used to control the disabling of the other control signals VG1_IN and VG2_IN. Accordingly, it is possible to reduce the possibility of erroneous detection of photons incident on the APD 111 before the recharge operation by the control signal VR_OUT.

In the present embodiment, the control circuit 202B controls the control signals VG1_OUT and VG2_OUT to rise in accordance with the falling edge of the control signal VR_OUT. However, the timing at which the control signals VG1_OUT and VG2_OUT rise is not limited thereto. If the timing at which the control signals VG1_OUT and VG2_OUT rise is after the rising edge of the control signal VR_OUT, that is, after the recharge operation is started, the effect of the present embodiment can be obtained.

In the present embodiment, it is assumed that the number of storage units in one pixel is two as in the second embodiment, but the number of storage units is not limited thereto. For example, the method of the present embodiment is also applicable to a case where the number of storage units in one pixel is one as in the first embodiment. In this case, the same effect can be obtained by using the control signal VR_OUT based on the control signal VR_IN, which is one of the control signals VG_IN and VR_IN synchronized with each other, for control of disabling of the other control signal VG_IN.

### Fourth Embodiment

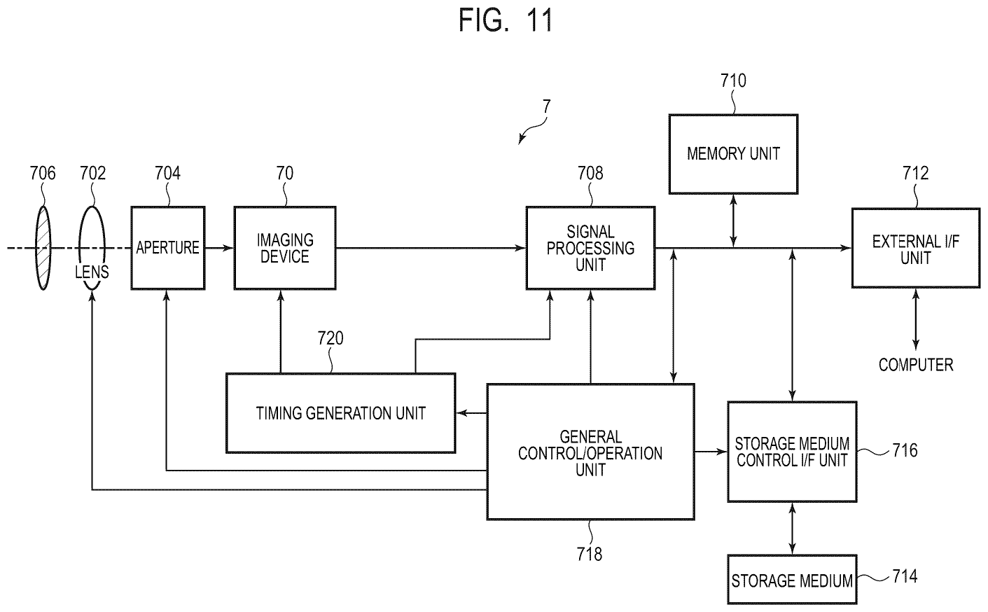

A photodetection system according to a fourth embodiment of the present invention will be described with reference to FIG. 11. FIG. 11 is a block diagram of a photodetection system according to the present embodiment. The photodetection system of the present embodiment is an imaging system that acquires an image based on incident light.

The photoelectric conversion device of the above-described embodiment may be applied to various imaging systems. Examples of the imaging system include a digital still camera, a digital camcorder, a camera head, a copying machine, a facsimile, a mobile phone, a vehicle-mounted camera, an observation satellite, and a surveillance camera. FIG. 11 is a block diagram of a digital still camera as an example of an imaging system.

The imaging system 7 illustrated in FIG. 11 includes a barrier 706, a lens 702, an aperture 704, an imaging device 70, a signal processing unit 708, a timing generation unit 720, a general control/operation unit 718, a memory unit 710, a storage medium control I/F unit 716, a storage medium 714, and an external I/F unit 712. The barrier 706 protects the lens, and the lens 702 forms an optical image of an object on the imaging device 70. The aperture 704 varies an amount of light passing through the lens 702. The imaging device 70 is configured as in the photoelectric conversion device of the above-described embodiment, and converts an optical image formed by the lens 702 into image data. The signal processing unit 708 performs various kinds of correction, data compression, and the like on the imaging data output from the imaging device 70.

The timing generation unit 720 outputs various timing signals to the imaging device 70 and the signal processing unit 708. The general control/operation unit 718 controls the entire digital still camera, and the memory unit 710 temporarily stores image data. The storage medium control I/F unit 716 is an interface for storing or reading out image data on the storage medium 714, and the storage medium 714 is a detachable storage medium such as a semiconductor memory for storing or reading out image data. The external I/F unit 712 is an interface for communicating with an external computer or the like. The timing signal or the like may be input from the outside of the imaging system 7, and the imaging system 7 may include at least the imaging device 70 and the signal processing unit 708 that processes an image signal output from the imaging device 70.

In the present embodiment, the imaging device 70 and the signal processing unit 708 may be arranged in the same semiconductor substrate. Further, the imaging device 70 and the signal processing unit 708 may be arranged in different semiconductor substrates.

Further, each pixel of the imaging device 70 may include a first photoelectric conversion unit and a second photoelectric conversion unit. The signal processing unit 708 processes a pixel signal based on a charge generated in the first photoelectric conversion unit and a pixel signal based on a charge generated in the second photoelectric conversion unit, and acquires the distance information from the imaging device 70 to the object.

### Fifth Embodiment

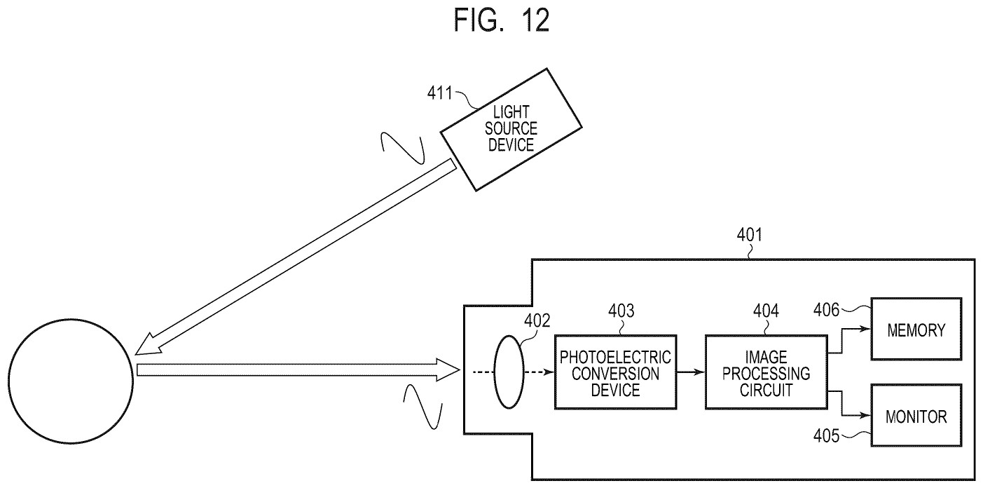

FIG. 12 is a block diagram of a photodetection system according to the present embodiment. More specifically, FIG. 12 is a block diagram of a distance image sensor using the photoelectric conversion device described in the above embodiment.

As illustrated in FIG. 12, the distance image sensor 401 includes an optical system 402, a photoelectric conversion device 403, an image processing circuit 404, a monitor 405, and a memory 406. The distance image sensor 401 receives light (modulated light or pulse light) emitted from the light source device 411 toward an object and reflected by the surface of the object. The distance image sensor 401 can acquire a distance image corresponding to a distance to the object based on a time period from light emission to light reception.

The optical system 402 includes one or a plurality of lenses, and guides image light (incident light) from the object to the photoelectric conversion device 403 to form an image on a light receiving surface (sensor unit) of the photoelectric conversion device 403.

As the photoelectric conversion device 403, the photoelectric conversion device of each of the embodiments described above can be applied. The photoelectric conversion device 403 supplies a distance signal indicating a distance obtained from the received light signal to the image processing circuit 404.

The image processing circuit 404 performs image processing for constructing a distance image based on the distance signal supplied from the photoelectric conversion device 403. The distance image (image data) obtained by the image processing can be displayed on the monitor 405 and stored (recorded) in the memory 406.

The distance image sensor 401 configured in this manner can acquire an accurate distance image by applying the photoelectric conversion device described above.

### Sixth Embodiment

The technology according to the present disclosure can be applied to various products. For example, the technology according to the present disclosure may be applied to an endoscopic surgical system, which is an example of a photodetection system.

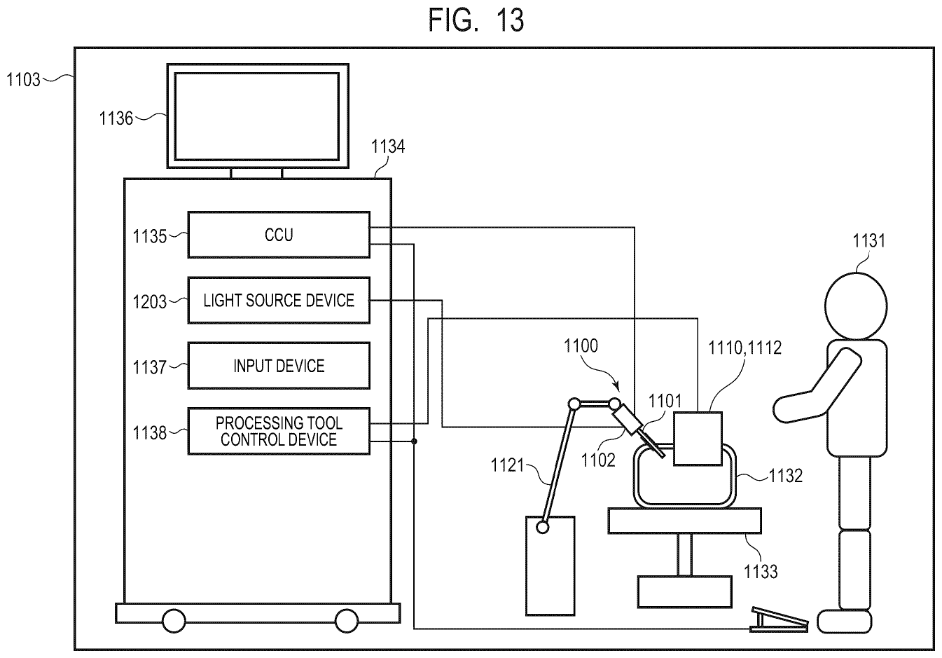

FIG. 13 is a schematic diagram of an endoscopic surgical system according to the present embodiment. FIG. 13 illustrates a state in which an operator (physician) 1131 performs surgery on a patient 1132 on a patient bed 1133 using an endoscopic surgical system 1103. As illustrated, the endoscopic surgical system 1103 includes an endoscope 1100, a surgical tool 1110, an arm 1121, and a cart 1134 on which various devices for endoscopic surgery are mounted.

The endoscope 1100 includes a barrel 1101 in which an area of a predetermined length from the distal end is inserted into a body cavity of a patient 1132, and a camera head 1102 connected to a proximal end of the barrel 1101. FIG. 13 illustrates an endoscope 1100 configured as a rigid scope having a rigid barrel 1101, but the endoscope 1100 may be configured as a flexible scope having a flexible barrel.

An opening into which an objective lens is fitted is provided at the distal end of the barrel 1101. A light source device 1203 is connected to the endoscope 1100. Light generated by the light source device 1203 is guided to the distal end of the barrel 1101 by a light guide extended inside the barrel 1101, and is irradiated to an observation target in the body cavity of the patient 1132 via an objective lens. The endoscope 1100 may be a straight-viewing scope an oblique-viewing scope, or a side-viewing scope.

An optical system and a photoelectric conversion device are provided inside the camera head 1102, and reflected light (observation light) from the observation target is focused on the photoelectric conversion device by the optical system. The observation light is photoelectrically converted by the photoelectric conversion device, and an electric signal corresponding to the observation light, that is, an image signal corresponding to an observation image is generated. As the photoelectric conversion device, the photoelectric conversion device described in each of the above embodiments can be used. The image signal is transmitted to a camera control unit (CCU) 1135 as RAW data.

The CCU 1135 includes a central processing unit (CPU), a graphics processing unit (GPU), and the like, and integrally controls operations of the endoscope 1100 and a display device 1136. Further, the CCU 1135 receives an image signal from the camera head 1102, and performs various types of image processing for displaying an image based on the image signal, such as development processing (demosaic processing).

The display device 1136 displays an image based on the image signal processed by the CCU 1135 under the control of the CCU 1135.

The light source device 1203 includes, for example, a light source such as a light emitting diode (LED), and supplies irradiation light to the endoscope 1100 when capturing an image of a surgical site or the like.

An input device 1137 is an input interface for the endoscopic surgical system 1103. The user can input various types of information and instructions to the endoscopic surgical system 1103 via the input device 1137.

A processing tool control device 1138 controls the actuation of the energy treatment tool 1112 for ablation of tissue, incision, sealing of blood vessels, and the like.

The light source device 1203 can supply irradiation light to the endoscope 1100 when capturing an image of a surgical site, and may be, for example, a white light source such as an LED, a laser light source, or a combination thereof. When a white light source is constituted by a combination of RGB laser light sources, the output intensity and output timing of each color (each wavelength) can be controlled with high accuracy. Therefore, the white balance of the captured image can be adjusted in the light source device 1203. In this case, laser light from each of the RGB laser light sources may be irradiated onto the observation target in a time-division manner, and driving of the imaging element of the camera head 1102 may be controlled in synchronization with the irradiation timing. Thus, images corresponding to R, G, and B can be captured in a time-division manner. According to such a method, a color image can be obtained without providing a color filter in the imaging element.

Further, the driving of the light source device 1203 may be controlled so that the intensity of the light output from the light source device 1203 is changed at predetermined time intervals. By controlling the driving of the imaging element of the camera head 1102 in synchronization with the timing of changing the intensity of light to acquire images in a time-division manner, and by synthesizing the images, it is possible to generate an image in a high dynamic range without so-called black out and white out.

Further, the light source device 1203 may be configured to be capable of supplying light in a predetermined wavelength band corresponding to special light observation. In the special light observation, for example, wavelength dependency of absorption of light in body tissue can be utilized. Specifically, predetermined tissues such as blood vessels in the surface layer of the mucosa are photographed with high contrast by irradiating light in a narrower band compared to the irradiation light (that is, white light) during normal observation. Alternatively, in the special light observation, fluorescence observation for obtaining an image by fluorescence generated by irradiation with excitation light may be performed. In the fluorescence observation, the body tissue can be irradiated with excitation light to observe fluorescence from the body tissue, or a reagent such as indocyanine green (ICG) can be locally injected to the body tissue and the body tissue can be irradiated with excitation light corresponding to the fluorescence wavelength of the reagent to obtain a fluorescence image. The light source device 1203 may be configured to supply narrowband light and/or excitation light corresponding to such special light observation.

### Seventh Embodiment

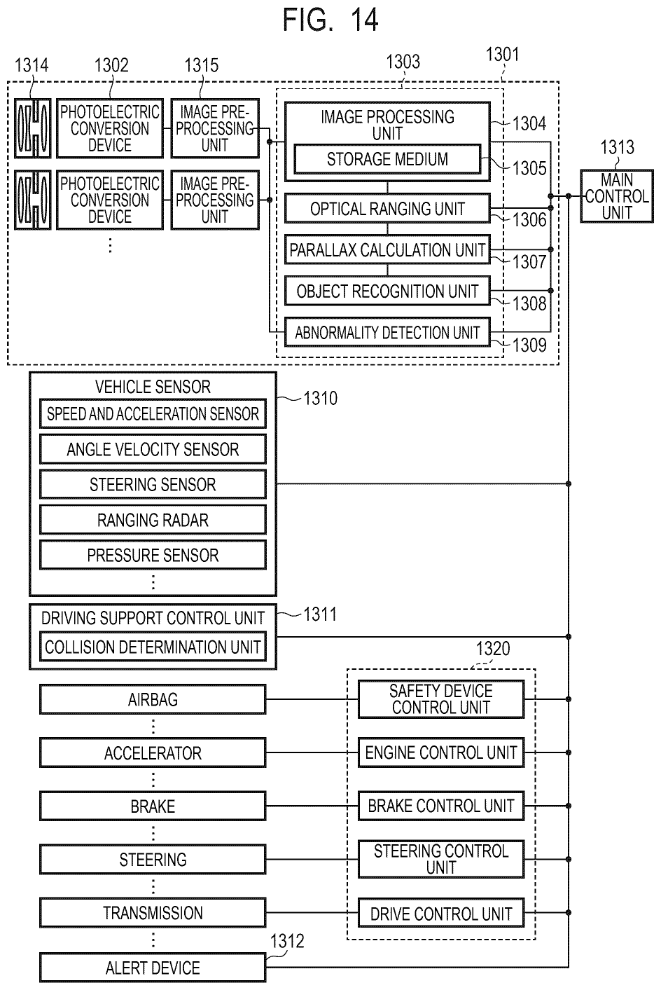

A photodetection system and a movable body of the present embodiment will be described with reference to FIGS. 14, 15A, 15B, 15C, and 16. In the present embodiment, an example of an in-vehicle camera is illustrated as a photodetection system.

FIG. 14 is a schematic diagram of a photodetection system according to the present embodiment, and illustrates an example of a vehicle system and a photodetection system mounted on the vehicle system. The photodetection system 1301 includes photoelectric conversion devices 1302, image pre-processing units 1315, an integrated circuit 1303, and optical systems 1314. The optical system 1314 forms an optical image of an object on the photoelectric conversion device 1302. The photoelectric conversion device 1302 converts the optical image of the object formed by the optical system 1314 into an electric signal. The photoelectric conversion device 1302 is the photoelectric conversion device of any one of the above-described embodiments. The image pre-processing unit 1315 performs predetermined signal processing on the signal output from the photoelectric conversion device 1302. The function of the image pre-processing unit 1315 may be incorporated in the photoelectric conversion device 1302. The photodetection system 1301 is provided with at least two sets of the optical system 1314, the photoelectric conversion device 1302, and the image pre-processing unit 1315, and an output signal from the image pre-processing units 1315 of each set is input to the integrated circuit 1303.

The integrated circuit 1303 is an integrated circuit for use in an imaging system, and includes an image processing unit 1304 including a storage medium 1305, an optical ranging unit 1306, a parallax calculation unit 1307, an object recognition unit 1308, and an abnormality detection unit 1309. The image processing unit 1304 performs image processing such as development processing and defect correction on the output signal of the image pre-processing unit 1315. The storage medium 1305 performs primary storage of captured images and stores defect positions of image capturing pixels. The optical ranging unit 1306 focuses or measures the object. The parallax calculation unit 1307 calculates distance measurement information from the plurality of image data acquired by the plurality of photoelectric conversion devices 1302. The object recognition unit 1308 recognizes an object such as a car, a road, a sign, or a person. When the abnormality detection unit 1309 detects the abnormality of the photoelectric conversion device 1302, the abnormality detection unit 1309 issues an abnormality to the main control unit 1313.

The integrated circuit 1303 may be realized by dedicated hardware, a software module, or a combination thereof. It may be realized by a field programmable gate array (FPGA), an application specific integrated circuit (ASIC), or the like, or may be realized by a combination of these.

The main control unit 1313 controls overall operations of the photodetection system 1301, a vehicle sensor 1310, a control unit 1320, and the like. Without the main control unit 1313, the photodetection system 1301, the vehicle sensor 1310, and the control unit 1320 may individually have a communication interface, and each of them may transmit and receive control signals via a communication network, for example, according to the CAN standard.

The integrated circuit 1303 has a function of transmitting a control signal or a setting value to the photoelectric conversion device 1302 by receiving a control signal from the main control unit 1313 or by its own control unit.

The photodetection system 1301 is connected to the vehicle sensor 1310, and can detect a traveling state of the host vehicle such as a vehicle speed, a yaw rate, a steering angle, and the like, an environment outside the host vehicle, and states of other vehicles and obstacles. The vehicle sensor 1310 is also a distance information acquisition unit that acquires distance information to the object. The photodetection system 1301 is connected to a driving support control unit 1311 (movable body control unit) that performs various driving support functions such as an automatic steering function, an automatic cruise function, and a collision prevention function. In particular, with regard to the collision determination function, based on detection results of the photodetection system 1301 and the vehicle sensor 1310, it is determined whether or not there is a possibility or occurrence of collision with another vehicle or an obstacle. Thus, avoidance control is performed when a possibility of collision is estimated and a safety device is activated when collision occurs.

The photodetection system 1301 is also connected to an alert device 1312 that issues an alarm to a driver based on a determination result of the collision determination unit. For example, when the possibility of collision is high as the determination result of the collision determination unit, the main control unit 1313 performs vehicle control such as braking, returning an accelerator, suppressing engine output, or the like, thereby avoiding collision or reducing damage. The alert device 1312 issues a warning to a user using means such as an alarm of a sound or the like, a display of alarm information on a display unit screen such as a car navigation system and a meter panel, and a vibration application to a seatbelt and a steering wheel.

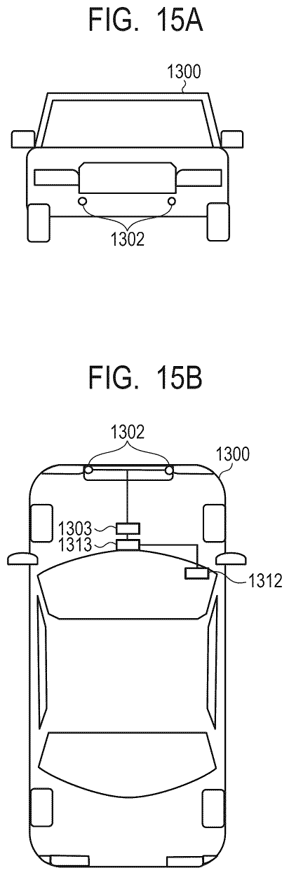

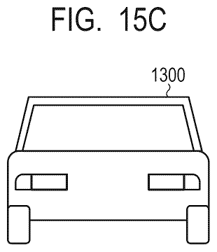

The photodetection system 1301 according to the present embodiment can capture an image around the vehicle, for example, the front or the rear. FIGS. 15A, 15B, and 15C are schematic diagrams of a movable body according to the present embodiment, and illustrate a configuration in which an image of the front of the vehicle is captured by the photodetection system 1301.

The two photoelectric conversion devices 1302 are arranged in front of the vehicle 1300. Specifically, it is preferable that a center line with respect to a forward/backward direction or an outer shape (for example, a vehicle width) of the vehicle 1300 be regarded as a symmetry axis, and two photoelectric conversion devices 1302 be arranged in line symmetry with respect to the symmetry axis. This makes it possible to effectively acquire distance information between the vehicle 1300 and the object to be imaged and determine the possibility of collision. Further, it is preferable that the photoelectric conversion device 1302 be arranged at a position where it does not obstruct the field of view of the driver when the driver sees a situation outside the vehicle 1300 from the driver's seat. The alert device 1312 is preferably arranged at a position that is easy to enter the field of view of the driver.

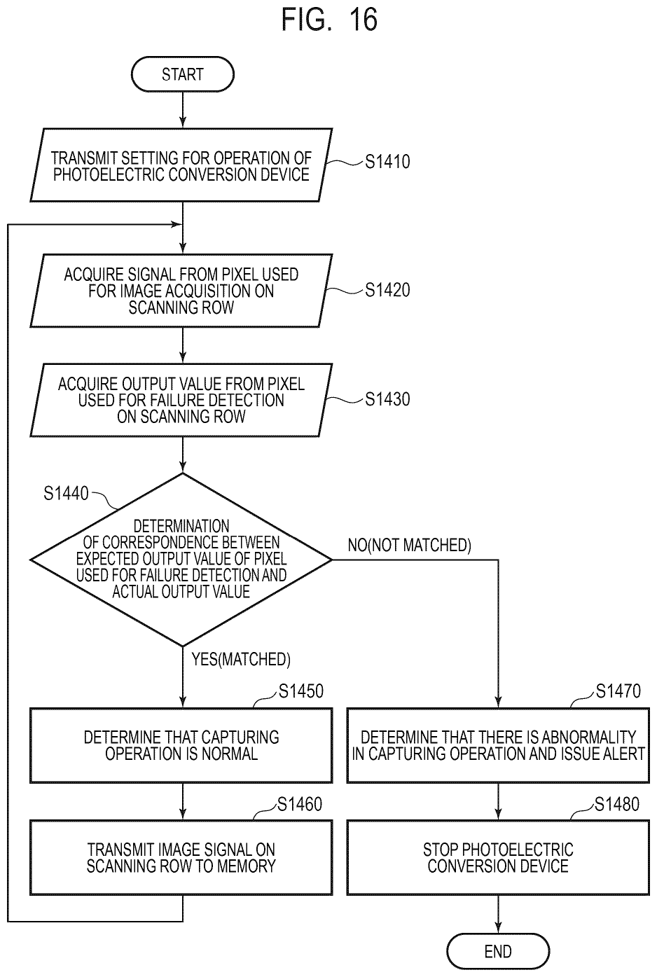

Next, a failure detection operation of the photoelectric conversion device 1302 in the photodetection system 1301 will be described with reference to FIG. 16. FIG. 16 is a flowchart illustrating an operation of the photodetection system according to the present embodiment. The failure detection operation of the photoelectric conversion device 1302 may be performed according to steps S1410 to S1480 illustrated in FIG. 16.

In step S1410, the setting at the time of startup of the photoelectric conversion device 1302 is performed. That is, setting information for the operation of the photoelectric conversion device 1302 is transmitted from the outside of the photodetection system 1301 (for example, the main control unit 1313) or the inside of the photodetection system 1301, and the photoelectric conversion device 1302 starts an imaging operation and a failure detection operation.

Next, in step S1420, the photoelectric conversion device 1302 acquires pixel signals from the effective pixels. In step S1430, the photoelectric conversion device 1302 acquires an output value from a failure detection pixel provided for failure detection. The failure detection pixel includes a photoelectric conversion element in the same manner as the effective pixel. A predetermined voltage is written to the photoelectric conversion element. The failure detection pixel outputs a signal corresponding to the voltage written in the photoelectric conversion element. Steps S1420 and S1430 may be executed in reverse order.

Next, in step S1440, the photodetection system 1301 performs a determination of correspondence between the expected output value of the failure detection pixel and the actual output value from the failure detection pixel. If it is determined in step S1440 that the expected output value matches the actual output value, the photodetection system 1301 proceeds with the process to step S1450, determines that the imaging operation is normally performed, and proceeds with the process to step S1460. In step S1460, the photodetection system 1301 transmits the pixel signals of the scanning row to the storage medium 1305 and temporarily stores them. Thereafter, the process of the photodetection system 1301 returns to step S1420 to continue the failure detection operation. On the other hand, as a result of the determination in step S1440, if the expected output value does not match the actual output value, the photodetection system 1301 proceeds with the process to step S1470. In step S1470, the photodetection system 1301 determines that there is an abnormality in the imaging operation, and issues an alert to the main control unit 1313 or the alert device 1312. The alert device 1312 causes the display unit to display that an abnormality has been detected. Then, in step S1480, the photodetection system 1301 stops the photoelectric conversion device 1302 and ends the operation of the photodetection system 1301.

Although the present embodiment exemplifies the example in which the flowchart is looped for each row, the flowchart may be looped for each plurality of rows, or the failure detection operation may be performed for each frame. The alert of step S1470 may be notified to the outside of the vehicle via a wireless network.

Further, in the present embodiment, the control in which the vehicle does not collide with another vehicle has been described, but the present embodiment is also applicable to a control in which the vehicle is automatically driven following another vehicle, a control in which the vehicle is automatically driven so as not to protrude from the lane, and the like. Further, the photodetection system 1301 can be applied not only to a vehicle such as a host vehicle, but also to a movable body (movable apparatus) such as a ship, an aircraft, or an industrial robot. In addition, the present embodiment can be applied not only to a movable body but also to an apparatus utilizing object recognition such as an intelligent transport systems (ITS).

The photoelectric conversion device of the present invention may be a configuration capable of further acquiring various types of information such as distance information.

### Eighth Embodiment

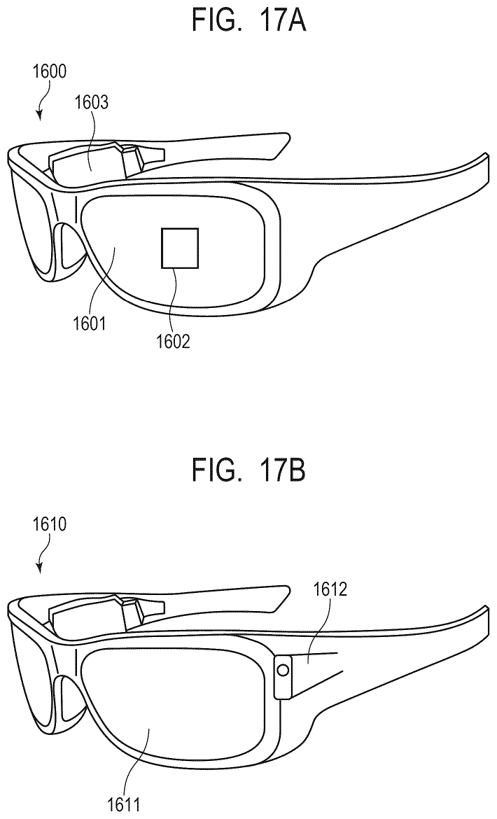

FIG. 17A is a diagram illustrating a specific example of an electronic device according to the present embodiment, and illustrates glasses 1600 (smart glasses). The glasses 1600 are provided with the photoelectric conversion device 1602 described in the above embodiments. That is, the glasses 1600 are an example of a photodetection system to which the photoelectric conversion device 1602 described in each of the above embodiments can be applied. A display device including a light emitting device such as an OLED or an LED may be provided on the back surface side of the lens 1601. One photoelectric conversion device 1602 or a plurality of photoelectric conversion devices 1602 may be provided. Further, a plurality of types of photoelectric conversion devices may be combined. The arrangement position of the photoelectric conversion device 1602 is not limited to that illustrated in FIG. 17A.

The glasses 1600 further comprise a control device 1603. The control device 1603 functions as a power source for supplying power to the photoelectric conversion device 1602 and the above-described display device. The control device 1603 controls operations of the photoelectric conversion device 1602 and the display device. The lens 1601 is provided with an optical system for collecting light to the photoelectric conversion device 1602.

FIG. 17B illustrates glasses 1610 (smart glasses) according to one application. The glasses 1610 include a control device 1612, and a photoelectric conversion device corresponding to the photoelectric conversion device 1602 and a display device are mounted on the control device 1612. The lens 1611 is provided with a photoelectric conversion device in the control device 1612 and an optical system for projecting light emitted from a display device, and an image is projected on the lens 1611. The control device 1612 functions as a power source for supplying power to the photoelectric conversion device and the display device, and controls operations of the photoelectric conversion device and the display device. The control device 1612 may include a line-of-sight detection unit that detects the line of sight of the wearer. Infrared radiation may be used to detect the line of sight. The infrared light emitting unit emits infrared light to the eyeball of the user who is watching the display image. The reflected light of the emitted infrared light from the eyeball is detected by an imaging unit having a light receiving element, whereby a captured image of the eyeball is obtained. A reduction unit that reduces light from the infrared light emitting unit to the display unit in a plan view may be employed and the reduction unit reduces a degradation in image quality.

The control device 1612 detects the line of sight of the user with respect to the display image from the captured image of the eyeball obtained by imaging the infrared light. Any known method can be applied to the line-of-sight detection using the captured image of the eyeball. As an example, a line-of-sight detection method based on a Purkinje image due to reflection of irradiation light at a cornea can be used.

More specifically, a line-of-sight detection process based on a pupil cornea reflection method is performed. By using the pupil cornea reflection method, a line-of-sight vector representing a direction (rotation angle) of the eyeball is calculated based on the image of the pupil included in the captured image of the eyeball and the Purkinje image, whereby the line-of-sight of the user is detected.

The display device of the present embodiment may include a photoelectric conversion device having a light receiving element, and may control a display image of the display device based on line-of-sight information of the user from the photoelectric conversion device.

Specifically, the display device determines a first view field region gazed by the user and a second view field region other than the first view field region based on the line-of-sight information. The first view field region and the second view field region may be determined by a control device of the display device, or may be determined by an external control device. In the display area of the display device, the display resolution of the first view field region may be controlled to be higher than the display resolution of the second view field region. That is, the resolution of the second view field region may be lower than that of the first view field region.

The display area may include a first display region and a second display region different from the first display region. A region having a high priority may be determined from the first display region and the second display region based on the line-of-sight information. The first view field region and the second view field region may be determined by a control device of the display device, or may be determined by an external control device. The resolution of the high priority area may be controlled to be higher than the resolution of the region other than the high priority region. That is, the resolution of a region having a relatively low priority can be reduced.

It should be noted that an artificial intelligence (AI) may be used in determining the first view field region and the region with high priority. The AI may be a model configured to estimate an angle of a line of sight and a distance to a target on the line-of-sight from an image of an eyeball, and the AI may be trained using training data including images of an eyeball and an angle at which the eyeball in the images actually gazes. The AI program may be provided in either a display device or a photoelectric conversion device, or may be provided in an external device. When the external device has the AI program, the AI program may be transmitted from a server or the like to a display device via communication.

When the display control is performed based on the line-of-sight detection, the present embodiment can be preferably applied to a smart glasses which further includes a photoelectric conversion device for capturing an image of the outside. The smart glasses can display captured external information in real time.

### Modified Embodiments

The present invention is not limited to the above embodiments, and various modifications are possible. For example, an example in which some of the configurations of any one of the embodiments are added to other embodiments and an example in which some of the configurations of any one of the embodiments are replaced with some of the configurations of other embodiments are also embodiments of the present invention.

The disclosure of this specification includes a complementary set of the concepts described in this specification. That is, for example, if a description of “A is B” (A=B) is provided in this specification, this specification is intended to disclose or suggest that “A is not B” even if a description of “A is not B” (A≠B) is omitted. This is because it is assumed that “A is not B” is considered when “A is B” is described.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

It should be noted that any of the embodiments described above is merely an example of an embodiment for carrying out the present invention, and the technical scope of the present invention should not be construed as being limited by the embodiments. That is, the present invention can be implemented in various forms without departing from the technical idea or the main features thereof.

According to the present invention, a semiconductor device capable of suitably synchronizing and controlling signals is provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-137310, filed Aug. 25, 2023, which is hereby incorporated by reference herein in its entirety.

What is claimed is:

1. A semiconductor device comprising:
a signal generation unit configured to generate a first signal;
a synchronization unit configured to synchronize the first signal with any one of a second signal and a third signal that are input from an outside and are synchronized with each other; and
a control unit configured to control at least one of the second signal and the third signal based on the first signal after synchronization is performed by the synchronization unit,
wherein the synchronization unit performs the synchronization by matching a timing at which a potential of the first signal changes to a later one of a timing at which a potential of the second signal changes and a timing at which a potential of the third signal changes.

2. The semiconductor device according to claim 1, wherein the control unit controls both the second signal and the third signal based on the first signal after synchronization is performed by the synchronization unit.

3. The semiconductor device according to claim 1, wherein the control unit performs control to switch between enabling and disabling of an external output of at least one of the second signal and the third signal.

4. The semiconductor device according to claim 1, wherein the control unit further controls, based on one of the second signal and the third signal controlled based on the first signal, the other of the second signal and the third signal.

5. The semiconductor device according to claim 1, wherein the control unit performs, based on one of the second signal and the third signal controlled based on the first signal, control to switch between enabling and disabling of an external output of the other of the second signal and the third signal.

6. The semiconductor device according to claim 1, wherein the synchronization unit includes a flip-flop circuit to which the first signal and any one of the second signal and the third signal are input.

7. A photoelectric conversion device comprising:
the semiconductor device according to claim 1; and
a pixel including a photoelectric conversion element, the pixel being controlled by a signal output from the semiconductor device.

8. The photoelectric conversion device according to claim 7, wherein the photoelectric conversion element is an avalanche photodiode.

9. The photoelectric conversion device according to claim 7, wherein the control unit controls whether or not at least one of the second signal and the third signal is supplied to the pixel.

10. The photoelectric conversion device according to claim 7, wherein the second signal indicates timing of initializing a potential of the photoelectric conversion element.

11. The photoelectric conversion device according to claim 7, wherein the third signal indicates timing of signal holding in the pixel.

12. The photoelectric conversion device according to claim 7,
wherein a fourth signal synchronized with the second signal and the third signal is further input to the synchronization unit, and
wherein the synchronization unit synchronizes the first signal with any one of the second signal, the third signal, and the fourth signal.

13. The photoelectric conversion device according to claim 12,
wherein each of the third signal and the fourth signal indicates timing of signal holding in the pixel, and
wherein the timing of signal holding indicated by the third signal and the timing of signal holding indicated by the fourth signal are different from each other.

14. The photoelectric conversion device according to claim 7,
wherein the signal generation unit further generates a fifth signal synchronized with the first signal, and
wherein the fifth signal indicates timing of signal output from the pixel.

15. The photoelectric conversion device according to claim 7,
wherein the signal generation unit further generates a sixth signal synchronized with the first signal, and
wherein the sixth signal indicates timing of initializing a signal held in the pixel, the signal being based on incident light to the photoelectric conversion element.

16. The photoelectric conversion device according to claim 7, wherein the photoelectric conversion device is configured to acquire distance information to an object by receiving light emitted from a light source whose emission timing is synchronized with the second signal and the third signal at the pixel.

17. A photodetection system comprising:
the photoelectric conversion device according to claim 1; and
a signal processing unit configured to process a signal output from the photoelectric conversion device.

18. A movable body comprising:
the photoelectric conversion device according to claim 1; and
a movable body control unit configured to control the movable body based on distance information generated by a signal output from the photoelectric conversion device.
